(19) United States
(12) Patent Application Publication
(10) Pub. No.: US 2006/0203794 A1
(43) Pub. Date: Sep. 14, 2006

(54) Systems and methods for beamforming in multi-input multi-output communication systems

(75) Inventors: Hemanth Sampath, San Diego, CA (US); Tamer Kadous, San Diego, CA (US); Alexei Gorokhov, San Diego, CA (US); Dhanajay Ashok Gore, San Diego, CA (US)

Correspondence Address: QUALCOMM INCORPORATED, 5775 MOREHOUSE DR., SAN DIEGO, CA, 92121, US

(73) Assignee: QUALCOMM Incorporated

(21) Appl. No.: 11/186,152

(22) Filed: Jul. 20, 2005

Related U.S. Application Data
(60) Provisional application No. 60/660,719, filed on Mar. 10, 2005.
(60) Provisional application No. 60/678,610, filed on May 6, 2005.
(60) Provisional application No. 60/691,467, filed on Jun. 16, 2005.
(60) Provisional application No. 60/691,432, filed on Jun. 16, 2005.

(51) Int. Cl. H04B 7/208

(52) U.S. Cl. 370/344

(57) ABSTRACT

Methods and apparatuses are disclosed that utilize information from less than all transmission paths from a transmitter to form beamforming weights for transmission. In addition, methods and apparatuses are disclosed that utilize channel information, such as CQI, eigenbeam weights, and/or channel estimates, to form beamforming weights.

### CLAIM OF PRIORITY UNDER 35 U.S.C. §119

The present Application for Patent claims priority to Provisional Application No. 60/660,719 entitled “Apparatus to Obtain Pseudo Eigen Beamforming Gains in MIMO Systems” filed Mar. 10, 2005, and Provisional Application Ser. No. 60/678,610 entitled “SYSTEM AND METHODS FOR GENERATING BEAMFORMING GAINS IN MULTI-INPUT MULTI-OUTPUT COMMUNICATION SYSTEMS” filed May 6, 2005 and Provisional Application Ser. No. 60/691,467 entitled “SYSTEMS AND METHODS FOR BEAMFORMING IN MULTI-INPUT MULTI-OUTPUT COMMUNICATION SYSTEMS” filed Jun. 16, 2005 and Provisional Application Ser. No. 60/691,432 entitled “SYSTEMS AND METHODS FOR BEAMFORMING AND RATE CONTROL IN A MULTI-INPUT MULTI-OUTPUT COMMUNICATION SYSTEM” filed Jun. 16, 2005 and assigned to the assignee hereof and hereby expressly incorporated by reference herein.

### I. Reference to Co-Pending Applications for Patent

The present Application is related to the following co-pending U.S. Patent Attorney Docket No. 050507U2 entitled “Systems And Methods For Beamforming In Multi-Input Multi-Output Communication Systems” and filed on even date herewith. Application is also related to U.S. Patent Application No. 60/660,925 filed Mar. 10, 2005; and U.S. Patent Application Ser. No. 60/667,705 filed Apr. 1, 2005 each of which are assigned to the assignee hereof, and expressly incorporated by reference herein.

### BACKGROUND

I. Field

The present document relates generally to wireless communication and amongst other things to beamforming for wireless communication systems.

II. Background

An orthogonal frequency division multiple access (OFDMA) system utilizes orthogonal frequency division multiplexing (OFDM). OFDM is a multi-carrier modulation technique that partitions the overall system bandwidth into multiple (N) orthogonal frequency subcarriers. These subcarriers may also be called tones, bins, and frequency channels. Each subcarrier is associated with a respective sub carrier that may be modulated with data. Up to N modulation symbols may be sent on the N total subcarriers in each OFDM symbol period. These modulation symbols are converted to the time-domain with an N-point inverse fast Fourier transform (IFFT) to generate a transformed symbol that contains N time-domain chips or samples.

In a frequency hopping communication system, data is transmitted on different frequency subcarriers during different time intervals, which may be referred to as “hop periods.” These frequency subcarriers may be provided by orthogonal frequency division multiplexing, other multi-carrier modulation techniques, or some other constructs. With frequency hopping, the data transmission hops from subcarrier to subcarrier in a pseudo-random manner. This hopping provides frequency diversity and allows the data transmission to better withstand deleterious path effects such as narrow-band interference, jamming, fading, and so on.

An OFDMA system can support multiple access terminals simultaneously. For a frequency hopping OFDMA system, a data transmission for a given access terminal may be sent on a “traffic” channel that is associated with a specific frequency hopping (FH) sequence. This FH sequence indicates the specific subcarriers to use for the data transmission in each hop period. Multiple data transmissions for multiple access terminals may be sent simultaneously on multiple traffic channels that are associated with different FH sequences. These FH sequences may be defined to be orthogonal to one another so that only one traffic channel, and thus only one data transmission, uses each subcarrier in each hop period. By using orthogonal FH sequences, the multiple data transmissions generally do not interfere with one another while enjoying the benefits of frequency diversity.

A problem that must be dealt with in all communication systems is that the receiver is located in a specific portion of an area served by the access point. In such cases, where a transmitter has multiple transmit antennas, the signals provided from each antenna need not be combined to provide maximum power at the receiver. In these cases, there may be problems with decoding of the signals received at the receiver. One way to deal with these problems is by utilizing beamforming.

Beamforming is a spatial processing technique that improves the signal-to-noise ratio of a wireless link with multiple antennas. Typically, beamforming may be used at either the transmitter and/or the receiver in a multiple antenna system. Beamforming provides many advantages in improving signal-to-noise ratios which improves decoding of the signals by the receiver.

A problem with beamforming for OFDM transmission systems is to obtain proper information regarding the channel(s) between a transmitter and receiver to generate beamforming weights in wireless communication systems, including OFDM systems. This is a problem due to the complexity required to calculate the beamforming weights and the need to provide sufficient information from the receiver to the transmitter.

### SUMMARY

In an embodiment, a wireless communication apparatus comprises at least two antennas and a processor. The processor is configured to generate beamforming weights based upon channel information corresponding to a number of transmission paths that is less than a total number of transmission paths from the wireless communication apparatus to the wireless communication device.

In another embodiment, a wireless communication apparatus comprises at least two antennas and means for generating beamforming weights based upon channel information corresponding to a number of transmission paths less than a number of transmission paths from transmission antennas of the at least two antennas to a wireless communication device.

In a further embodiment, a method for forming beamforming weights comprises reading channel information corresponding to a number of transmission paths less than a number of transmission paths between a wireless transmitter and a wireless receiver and generating beamforming weights based upon the channel information for transmission from the transmit antennas of the wireless transmitter.

In an additional embodiment, a wireless communication apparatus comprises at least two antennas and a processor configured to generate beamforming weights, for transmission of symbols to a wireless communication device, based upon channel information corresponding to a number of receive antennas of the wireless communication device, wherein the number of receive antennas is less than a total number of antennas utilized for reception at the wireless communication device.

In yet another embodiment, a wireless communication apparatus comprises at least two antennas and means for generating beamforming weights based upon channel information corresponding to a number of channels less than a number of receive antennas at a wireless communication device.

In additional embodiments, the eigenbeam weights generated at the wireless communication device may provided to the wireless communication apparatus and used in addition to or in lieu of the channel information.

In some embodiments, channel information may include channel statistics, CQI, and/or channel estimates.

It is understood that other aspects of the present disclosure will become readily apparent to those skilled in the art from the following detailed description, wherein is shown and described only exemplary embodiments of the invention, simply by way of illustration. As will be realized, the embodiments disclosed are capable of other and different embodiments and aspects, and its several details are capable of modifications in various respects, all without departing from the scope of the disclosure.

### BRIEF DESCRIPTION OF THE DRAWINGS

The features, nature, and advantages of the present embodiments may become more apparent from the detailed description set forth below when taken in conjunction with the drawings in which like reference characters identify correspondingly throughout and wherein:

FIG. 1 illustrates a multiple access wireless communication system according to one embodiment;

FIG. 2 illustrates a spectrum allocation scheme for a multiple access wireless communication system according to one embodiment;

FIG. 3 illustrates a block diagram of a time frequency allocation for a multiple access wireless communication system according to one embodiment;

FIG. 4 illustrates a transmitter and receiver in a multiple access wireless communication system according to one embodiment;

FIG. 5a illustrates a block diagram of a forward link in a multiple access wireless communication system according to one embodiment;

FIG. 5b illustrates a block diagram of a reverse link in a multiple access wireless communication system according to one embodiment;

FIG. 6 illustrates a block diagram of a transmitter system in a multiple access wireless communication system according to one embodiment;

FIG. 7 illustrates a block diagram of a receiver system in a multiple access wireless communication system according to one embodiment;

FIG. 8 illustrates a flow chart of generating beamforming weights according to one embodiment;

FIG. 9 illustrates a flow chart of generating beamforming weights according to another embodiment; and

FIG. 10 illustrates a flow chart of generating beamforming weights according to a further embodiment.

### DETAILED DESCRIPTION

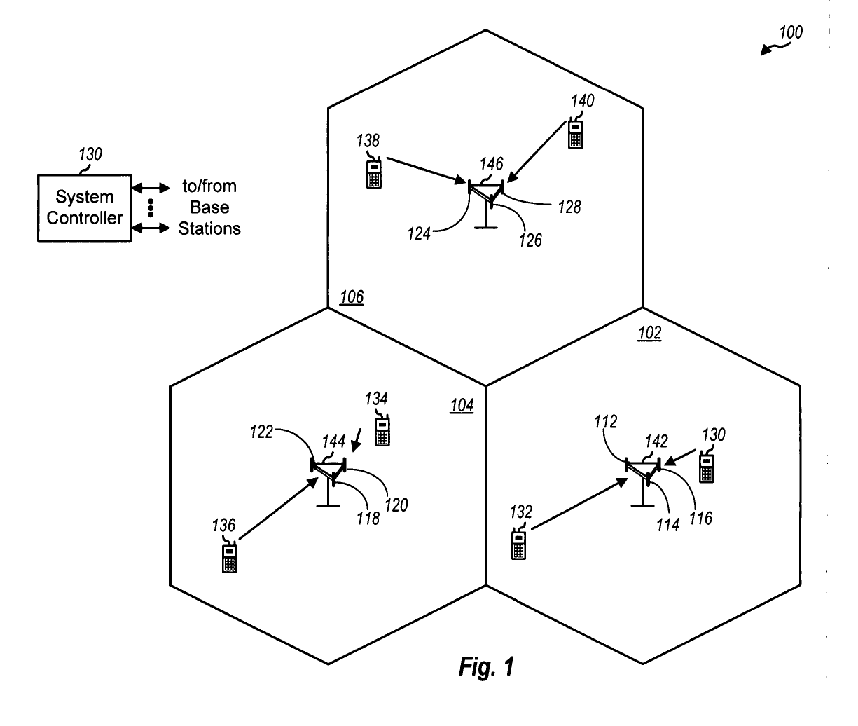

Referring to FIG. 1, a multiple access wireless communication system according to one embodiment is illustrated. A multiple access wireless communication system 100 includes multiple cells, e.g. cells 102, 104, and 106. In the embodiment of FIG. 1, each cell 102, 104, and 106 may include an access point 150 that includes multiple sectors. The multiple sectors are formed by groups of antennas each responsible for communication with access terminals in a portion of the cell. In cell 102, antenna groups 112, 114, and 116 each correspond to a different sector. In cell 104, antenna groups 118, 120, and 122 each correspond to a different sector. In cell 106, antenna groups 124, 126, and 128 each correspond to a different sector.

Each cell includes several access terminals which are in communication with one or more sectors of each access point. For example, access terminals 130 and 132 are in communication base 142, access terminals 134 and 136 are in communication with access point 144, and access terminals 138 and 140 are in communication with access point 146.

It can be seen from FIG. 1 that each access terminal 130, 132, 134, 136, 138, and 140 is located in a different portion of it respective cell than each other access terminal in the same cell. Further, each access terminal may be a different distance from the corresponding antenna groups with which it is communicating. Both of these factors, along with environmental conditions in the cell, cause different channel conditions to be present between each access terminal and its corresponding antenna group with which it is communicating.

As used herein, an access point may be a fixed station used for communicating with the terminals and may also be referred to as, and include some or all the functionality of, a base station, a Node B, or some other terminology. An access terminal may also be referred to as, and include some or all the functionality of, a user equipment (UE), a wireless communication device, a terminal, a mobile station or some other terminology.

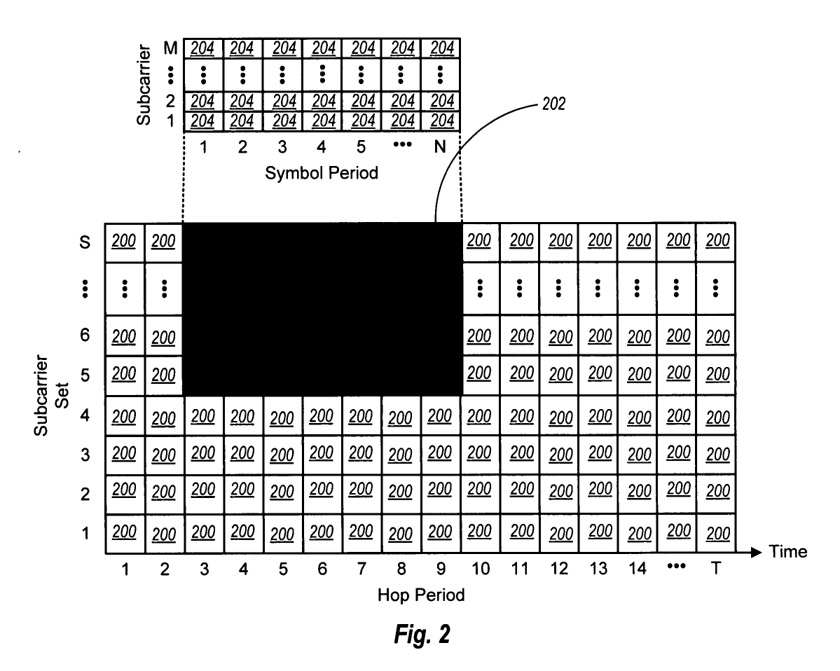

Referring to FIG. 2, a spectrum allocation scheme for a multiple access wireless communication system is illustrated. A plurality of OFDM symbols 200 is allocated over T symbol periods and S frequency subcarriers. Each OFDM symbol 200 comprises one symbol period of the T symbol periods and a tone or frequency subcarrier of the S subcarriers.

In an OFDM frequency hopping system, one or more symbols 200 may be assigned to a given access terminal. In one embodiment of an allocation scheme as shown in FIG. 2, one or more hop regions, e.g. hop region 202, of symbols are assigned to a group of access terminals for communication over a reverse link. Within each hop region, assignment of symbols may be randomized to reduce potential interference and provide frequency diversity against deleterious path effects.

Each hop region 202 includes symbols 204 that are assigned to, for transmission to on the forward link and receipt from on the reverse link, the one or more access terminals that are in communication with the sector of the access point. During each hop period, or frame, the location of hop region 202 within the T symbol periods and S subcarriers varies according to a hopping sequence. In addition, the assignment of symbols 204 for the individual access terminals within hop region 202 may vary for each hop period.

The hop sequence may pseudo-randomly, randomly, or according to a predetermined sequence, select the location of the hop region 202 for each hop period. The hop sequences for different sectors of the same access point are designed to be orthogonal to one another to avoid “intra-cell” interference among the access terminal communicating with the same access point. Further, hop sequences for each access point may be pseudo-random with respect to the hop sequences for nearby access points. This may help randomize “inter-cell” interference among the access terminals in communication with different access points.

In the case of a reverse link communication, some of the symbols 204 of a hop region 202 are assigned to pilot symbols that are transmitted from the access terminals to the access point. The assignment of pilot symbols to the symbols 204 should preferably support space division multiple access (SDMA), where signals of different access terminals overlapping on the same hop region can be separated due to multiple receive antennas at a sector or access point, provided enough difference of spatial signatures corresponding to different access terminals.

It should be noted that while FIG. 2 depicts hop region 200 having a length of seven symbol periods, the length of hop region 200 can be any desired amount, may vary in size between hop periods, or between different hopping regions in a given hop period.

It should be noted that while the embodiment of FIG. 2 is described with respect to utilizing block hopping, the location of the block need not be altered between consecutive hop periods.

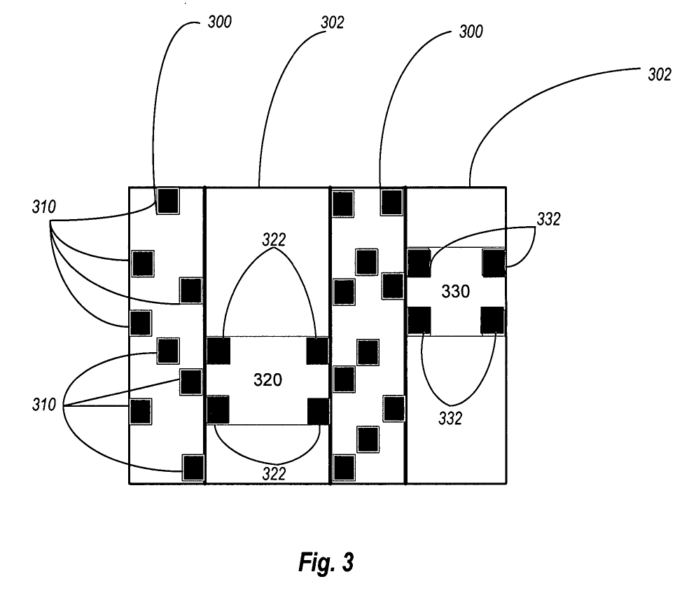

Referring to FIG. 3, a block diagram of a time frequency allocation for a multiple access wireless communication system according to one embodiment is illustrated. The time frequency allocation includes time periods 300 that include broadcast pilot symbols 310 transmitted from an access point to all access terminals in communication with it. The time frequency allocation also includes time periods 302 that include one or more hop regions 320 each of which includes one or more dedicated pilot symbols 322, which are transmitted to one or more desired access terminals. The dedicated pilot symbols 322 may include the same beamforming weights that are applied to the data symbols transmitted to the access terminals.

The broadband pilot symbols 310 and dedicated pilot symbols 322 may be utilized by the access terminals to generate channel quality information (CQI) regarding the channels between the access terminal and the access point for the channel between each transmit antenna that transmits symbols and receive antenna that receives these symbols. In an embodiment, the channel estimate may constitute noise, signal-to-noise ratios, pilot signal power, fading, delays, path-loss, shadowing, correlation, or any other measurable characteristic of a wireless communication channel.

In an embodiment, the CQI, which may be the effective signal-to-noise ratios (SNR), can be generated and provided to the access point separately for broadband pilot symbols 310 (referred to as the broadband CQI). The CQI may also be the effective signal-to-noise ratios (SNR) that are generated and provided to the access point separately for dedicated pilot symbols 322 (referred to as the dedicated-CQI or the beamformed CQI). This way, the access point can know the CQI for the entire bandwidth available for communication, as well as for the specific hop regions that have been used for transmission to the access terminal. The CQI from both broadband pilot symbols 310 and dedicated pilot symbols 322, independently, may provide more accurate rate prediction for the next packet to be transmitted, for large assignments with random hopping sequences and consistent hop region assignments for each user. Regardless of what type of CQI is fed-back, in some embodiments the broadband-CQI nis provided from the access terminal to the access point periodically and may be utilized for a power allocation on one or more forward link channels, such as forward link control channels.

Further, in those situation where the access terminal is not scheduled for forward link transmission or is irregularly scheduled, i.e. the access terminal is not scheduled for forward link transmission in during each hop period, the broadband-CQI can be provided to the access point for the next forward link transmission on a reverse link channel, such as the reverse link signaling or control channel. This broadband-CQI does not include beamforming gains since the broadband pilot symbols 310 are generally not beamformed.

In one embodiment, the access-point can derive the beamforming weights based upon its channel estimates using reverse link transmissions from the access terminal. The access point may derive channel estimates based upon symbols including the CQI transmitted from the access terminal over a dedicated channel, such as a signaling or control channel dedicated for feedback from the access terminal. The channel estimates may be utilized for beamforming weight generation instead of the CQI.

In another embodiment, the access-point can derive the beamforming weights based upon channel estimates determined at the access terminal and provided over a reverse link transmissions to the access point.. If the access terminal also has a reverse link assignment in each frame or hop period, whether in a separate or same hop period or frame as the forward link transmission, the channel estimate information may provided in the scheduled reverse link transmissions to the access point. The transmitted channel estimates may be utilized for beamforming weight generation.

In another embodiment, the access-point can receive the beamforming weights from the access terminal over a reverse link transmission. If the access terminal also has a reverse link assignment in each frame or hop period, whether in a separate or same hop period or frame as the forward link transmission, the beamforming weights may be provided in the scheduled reverse link transmissions to the access point.

As used herein, the CQI, channel estimates, eigenbeam feedback, or combinations thereof may termed as channel information utilized by an access point to generate beamforming weights.

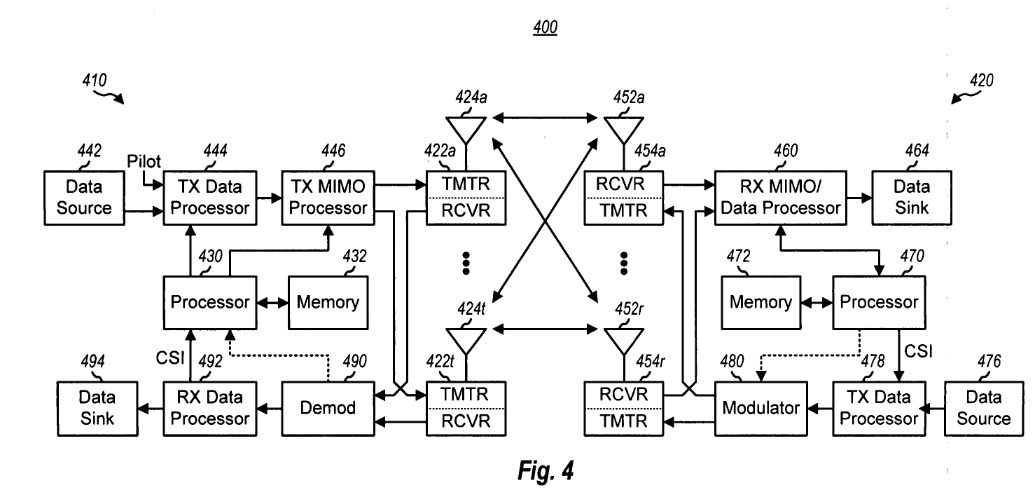

Referring to FIG. 4, a transmitter and receiver in a multiple access wireless communication system according to one embodiment is illustrated. At transmitter system 410, traffic data for a number of data streams is provided from a data source 412 to a transmit (TX) data processor 444. In an embodiment, each data stream is transmitted over a respective transmit antenna. TX data processor 444 formats, codes, and interleaves the traffic data for each data stream based on a particular coding scheme selected for that data stream to provide coded data. In some embodiments, TX data processor 444 applies beamforming weights to the symbols of the data streams based upon the user to which the symbols are being transmitted and the antenna from which the symbol is being transmitted. In some embodiments, the beamforming weights may be generated based upon channel response information that is indicative of the condition of the transmission paths between the access point and the access terminal. The channel response information may be generated utilizing CQI information or channel estimates provided by the user. Further, in those cases of scheduled transmissions, the TX data processor 444 can select the packet format based upon rank information that is transmitted from the user.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed on provided by processor 430. In some embodiments, the number of parallel spatial streams may be varied according to the rank information that is transmitted from the user.

The modulation symbols for all data streams are then provided to a TX MIMO processor 446, which may further process the modulation symbols (e.g., for OFDM). TX MIMO processor 446 then provides NT symbol streams to NT transmitters (TMTR) 422a through 422t. In certain embodiments, TX MIMO processor 420 applies beamforming weights to the symbols of the data streams based upon the user to which the symbols are being transmitted and the antenna from which the symbol is being transmitted from that users channel response information.

Each transmitter 422 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 422a through 422t are then transmitted from NT antennas 424a through 424t, respectively.

At receiver system 420, the transmitted modulated signals are received by NR antennas 452a through 452r and the received signal from each antenna 452 is provided to a respective receiver (RCVR) 454a through 454r. Each receiver 454 conditions (e.g., filters, amplifies, and downconverts) a respective received signal, digitizes the conditioned signal to provide samples, and further processes the samples to provide a corresponding “received” symbol stream.

An RX data processor 460 then receives and processes the NR received symbol streams from NR receivers 454a through 454r based on a particular receiver processing technique to provide the rank number of “detected” symbol streams. The processing by RX data processor 460 is described in further detail below. Each detected symbol stream includes symbols that are estimates of the modulation symbols transmitted for the corresponding data stream. RX data processor 460 then demodulates, deinterleaves, and decodes each detected symbol stream to recover the traffic data for the data stream which is provided to data sink 464 for storage and/or further processing. The processing by RX data processor 460 is complementary to that performed by TX MIMO processor 446 and TX data processor 444 at transmitter system 410.

The channel response estimate generated by RX processor 460 may be used to perform space, space/time processing at the receiver, adjust power levels, change modulation rates or schemes, or other actions. RX processor 460 may further estimate the signal-to-noise-and-interference ratios (SNRs) of the detected symbol streams, and possibly other channel characteristics, and provides these quantities to a processor 470. RX data processor 460 or processor 470 may further derive an estimate of the “effective” SNR for the system. Processor 470 then provides estimated channel information (CSI), which may comprise various types of information regarding the communication link and/or the received data stream. For example, the CSI may comprise only the operating SNR. The CSI is then processed by a TX data processor 478, which also receives traffic data for a number of data streams from a data source 476, modulated by a modulator 480, conditioned by transmitters 454a through 454r, and transmitted back to transmitter system 410.

At transmitter system 410, the modulated signals from receiver system 450 are received by antennas 424, conditioned by receivers 422, demodulated by a demodulator 490, and processed by a RX data processor 492 to recover the CSI reported by the receiver system and to provide data to data sink 494 for storage and/or further processing. The reported CSI is then provided to processor 430 and used to (1) determine the data rates and coding and modulation schemes to be used for the data streams and (2) generate various controls for TX data processor 444 and TX MIMO processor 446.

It should be noted that the transmitter 410 transmits multiple steams of sysmbols to multiple receivers, e.g. access terminals, while receiver 420 transmits a single data stream to a single structure, e.g. an access point, thus accounting for the differing receive and transmit chains depicted. However, both may be MIMO transmitters thus making the receive and transmit identical.

At the receiver, various processing techniques may be used to process the NR received signals to detect the NT transmitted symbol streams. These receiver processing techniques may be grouped into two primary categories (i) spatial and space-time receiver processing techniques (which are also referred to as equalization techniques); and (ii) “successive nulling/equalization and interference cancellation” receiver processing technique (which is also referred to as “successive interference cancellation” or “successive cancellation” receiver processing technique).

A MIMO channel formed by the NT transmit and NR receive antennas may be decomposed into NS independent channels, with N_{S}≦min {N_{T}, N_{R})}. Each of the NS independent channels may also be referred to as a spatial subchannel (or a transmission channel) of the MIMO channel and corresponds to a dimension.

For a full-rank MIMO channel, where N_{S}=N_{T}≦N_{R}, an independent data stream may be transmitted from each of the NT transmit antennas. The transmitted data streams may experience different channel conditions (e.g., different fading and multipath effects) and may achieve different signal-to-noise-and-interference ratios (SNRs) for a given amount of transmit power. Moreover, in those cases that successive interference cancellation processing is used at the receiver to recover the transmitted data streams, and then different SNRs may be achieved for the data streams depending on the specific order in which the data streams are recovered. Consequently, different data rates may be supported by different data streams, depending on their achieved SNRs. Since the channel conditions typically vary with time, the data rate supported by each data stream also varies with time.

The MIMO design may have two modes of operation, single code word (SCW) and multiple-code word (MCW). In MCW mode, the transmitter can encode the data transmitted on each spatial layer independently, possibly with different rates. The receiver employs a successive interference cancellation (SIC) algorithm which works as follows: decode the first layer, and then subtract its contribution from the received signal after re-encoding and multiplying the encoded first layer with an “estimated channel,” then decode the second layer and so on. This “onion-peeling” approach means that each successively decoded layer sees increasing SNR and hence can support higher rates. In the absence of error-propagation, MCW design with SIC achieves maximum system transmission capacity based upon the channel conditions. The disadvantage of this design arise from the burden of “managing” the rates of each spatial layer: (a) increased CQI feedback (one CQI for each layer needs to be provided); (b) increased acknowledgement (ACK) or negative acknowledgement (NACK) messaging (one for each layer); (c) complications in Hybrid ARQ (HARQ) since each layer can terminate at different transmissions; (d) performance sensitivity of SIC to channel estimation errors with increased Doppler, and/or low SNR; and (e) increased decoding latency requirements since each successive layer cannot be decoded until prior layers are decoded.

In a SCW mode design, the transmitter encodes the data transmitted on each spatial layer with “identical data rates.” The receiver can employ a low complexity linear receiver such as a Minimum Mean Square Solution (MMSE) or Zero Frequency (ZF) receiver, or non-linear receivers such as QRM, for each tone. This allows reporting of the CQI by the receiver to be for only the “best” rank and hence results in reduced transmission overhead for providing this information.

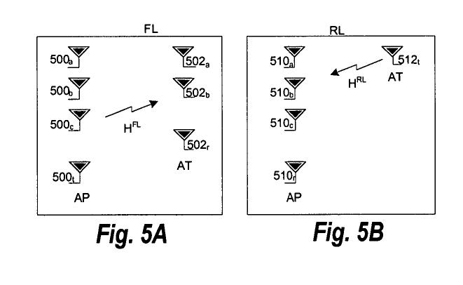

Referring to FIG. 5A a block diagram of a forward link in a multiple access wireless communication system according to one embodiment is illustrated. A forward link channel may be modeled as a transmission from multiple transmit antennas 500a to 500t at an access point (AP) to multiple receipt antennas 502a to 502r at an access terminal (AT). The forward link channel, HFL, may be defined as the collection of the transmission paths from each of the transmit antennas 500a to 500t to each of the receive antennas 502a to 502r.

Referring to FIG. 5B a block diagram of a reverse link in a multiple access wireless communication system according to one embodiment is illustrated. A reverse link channel may be modeled as a transmission from one or more transmit antennas, e.g. antenna 512t at an access terminal (AT), user station, access terminal, or the like to multiple receipt antennas 510a to 510r at an access point (AP), access point, node b, or the like. The reverse link channel, HRL, may be defined as the collection of the transmission paths from the transmit antenna 512t to each of the receipt antennas 510a to 510r.

As can be seen in FIGS. 5A and 5B, each access terminal (AT) may have one or more antennas. In some embodiments, the number of antennas 512t used for transmission is less than the number of antennas used for reception 502a to 502r at the access terminal (AT). Further, in many embodiments the number of transmit antennas 500a to 500t at each access point (AP) is greater than either or both the number of transmit or receive antennas at the access terminal.

In time division duplexed communication, full channel reciprocity does not exist if the number of antennas used to transmit at the access terminal is less than the number of antennas used for reception at the access terminal. Hence, the forward link channel for all of the receive antennas at the access terminal is difficult to obtain.

In frequency division duplexed communication, feeding back channel state information for all of the eigenbeams of the forward link channel matrix may be inefficient or nearly impossible due to limited reverse link resources. Hence, the forward link channel for all of the receive antennas at the access terminal is difficult to obtain.

In an embodiment, the channel feedback is provided from the access terminal to the access point, for a subset of possible transmission paths between the transmit antennas access point and the receive antennas of the access terminal.

In an embodiment, the feedback may comprise of the CQI generated by the access point based upon one or more symbols transmitted from the access terminal to the access point, e.g. over a pilot or control channel. In these embodiments, the channel estimates for the number of transmission paths equal to the number of transmit antennas utilized at the access terminal for each receive antenna of the access point, may be derived from the CQI, by treating it like a pilot. This allows the beamforming weights to be recomputed on a regular basis and therefore be more accurately responsive to the conditions of the channel between the access terminal and the access point. This approach reduces the complexity of the processing required at the access terminal, since there is no processing related to generating beamforming weights at the access terminal.

A beam-construction matrix may be generated at the Access Point using channel estimates obtained from the CQI, B(k)=[h^{FL}(k)*b₂ . . . b_{M}] Where b₂, b₃, . . . , b_{M} are random vectors. and is h^{FL}(k) is the channel derived by using the CQI as a pilot. The information for hFL(k) may obtained by determining hRL(k)) at the access point (AP). Note that hRL(k) is the channel estimates of the responsive pilot symbols transmitted from the transmit antenna(s) of the access terminal (AT) on the reverse link. It should be noted that hRL is only provided for a number of transmit antennas at the access terminal, depicted as being one in FIG. 5B, which is less than the number of receive antennas at the access terminal, depicted as being r in FIG. 5A. The channel matrix hFL(k) is obtained by calibrating hRL(k) by utilizing matrix A, which is a function of the differences between the reverse link channel and the calculated forward link information received from the access terminal. In one embodiment, the matrix Λ may defined as shown below, where λ₁ are the calibration errors for each channel,

$$Λ = [ \begin{matrix}{λ}_{1} & 0 & ⋯ & 0 \\ 0 & {λ}_{2} & ⋯ & ⋯ \\ ⋯ & ⋯ & ⋯ & 0 \\ 0 & ⋯ & 0 & {λ}_{{M}_{T}}\end{matrix} ]$$

In order to calculate the calibration errors, both the forward link and reverse link channel information may be utilized. In some embodiments, the coefficients λ₁ may be determined based upon overall channel conditions at regular intervals and are not specific to any particular access terminal that is in communication with the access point. In other embodiments, the coefficients λ₁ may be determined by utilizing an average from each of the access terminals in communication with the access point.

In another embodiment, the feedback may comprise of the eigenbeams calculated at the access terminal based upon pilot symbols transmitted from the access point. The eigenbeams may be averaged over several forward link frames or relate to a single frame. Further, in some embodiments, the eigenbeams may be averaged over multiple tones in the frequency domain. In other embodiments, only the dominant eigenbeams of the forward link channel matrix are provided. In other embodiments, the dominant eigenbeams may be averaged for two or more frames in the time-domain, or may be averaged over multiple tones in the frequency domain. This may be done to reduce both the computational complexity at the access terminal and the required transmission resources to provide the eigenbeams from the access terminal to the access point. An example beam-construction matrix generated at the access point, when 2 quantized eigenbeams are provided is given as: B(k)=[q₁(k)q₂(k) b₃ . . . b_{M}], where q₁(k) are the quantized eigenbeams that are provided and b3 . . . bM are dummy vectors or otherwise generated by the access terminal.

In another embodiment, the feedback may comprise of the quantized channel estimates calculated at the access terminal based upon pilot symbols transmitted from the access point. The channel estimates may be averaged over several forward link frames or relate to a single frame. Further, in some embodiments, the channel estimates may be averaged over multiple tones in the frequency domain. An example beam-construction matrix generated at the access point when 2 rows of the FL-MIMO channel matrix are provided is given as: B(k)=└ [symbol] H^{FL} [symbol] ₁ [symbol] H^{FL} [symbol] ₂ b₃ . . . b_{M}┘ [symbol] H^{FL} [symbol] ₁ is the i-th row of the FL-MIMO channel matrix.

In another embodiment, the feedback may comprise second order statistics of the channel, namely the transmit correlation matrix, calculated at the access terminal based upon pilot symbols transmitted from the access point. The second order statistics may be averaged over several forward link frames or relate to a single frame. In some embodiments, the channel statistics may be averaged over multiple tones in the frequency domain. In such a case, the eigenbeams can be derived from the transmit correlation matrix at the AP, and a beam-construction matrix can be created as: B(k)=[q₁(k) q₂(k) q₃(k) . . . q_{M}(k)] where qᵢ(k) are the eigenbeams

In another embodiment, the feedback may comprise the eigenbeams of the second order statistics of the channel, namely the transmit correlation matrix, calculated at the access terminal based upon pilot symbols transmitted from the access point. The eigenbeams may be averaged over several forward link frames or relate to a single frame. Further, in some embodiments, the eigenbeams may be averaged over multiple tones in the frequency domain. In other embodiments, only the dominant eigenbeams of the transmit correlation matrix are provided. The dominant eigenbeams may be averaged over several forward link frames or relate to a single frame. Further, in some embodiments, the dominant eigenbeams may be averaged over multiple tones in the frequency domain. An example beam-construction matrix are when 2 quantized eigenbeams are feedback is given as: B(k)=[q₁(k) q₂(k) b₃ . . . b_{M}], where q₁ (k) are the quantized eigenbeams per-hop of the transmit correlation matrix

In further embodiments, the beam-construction matrix may be generated by a combination of channel estimate obtained from CQI and dominant eigenbeam feedback. An example beam-construction matrix is given as:
B=[h*_{FL}x₁ . . . b_{M}] Eq. 5
where x1 is a dominant eigenbeam for a particular hFL and h*_{FL} is based on the CQI.

In other embodiments, the feedback may comprise of the CQI and estimated eigenbeams, channel estimates, transmit correlation matrix, eigenbeams of the transmit correlation matrix or any combination thereof.

A beam-construction matrix may be generated at the Access Point using channel estimates obtained from the CQI, estimated eigenbeams, channel estimates, transmit correlation matrix, eigenbeams of the transmit correlation matrix or any combination thereof.

In order to form the beamforming vectors for each transmission a QR decomposition of the beam-construction matrix B is performed to form pseudo-eigen vectors that each corresponds to a group of transmission symbols transmitted from the MT antennas to a particular access terminal.
V=QR(B)
V=[v₁ v₂ . . . v_{M}] Eq. 6
are pseudo-eigen vectors.

The individual scalars of the beamform vectors represent the beamforming weights that are applied to the symbols transmitted from the MT antennas to each access terminal. These vectors then are formed by the following:

$${F}_{M} = \frac{1}{M} [ {v}_{1} {v}_{2} ⋯ {v}_{M} ] \qquad Eq . 7$$

where M is the number of layers utilized for transmission.

In order to decide how many eigenbeams should be used (rank prediction), and what transmission mode should be used to obtain maximum eigenbeamforming gains, several approaches may be utilized. If the access terminal is not scheduled, an estimate, e.g., a 7-bit channel estimate that may include rank information, may be computed based on the broadband pilots and reported along with the CQI. The control or signaling channel information transmitted from the access terminal, after being decoded, acts as a broadband pilot for the reverse link. By using this channel, the beamforming weights may be computed as shown above. The CQI computed also provides information for the rate prediction algorithm at the transmitter.

Alternatively, if the access terminal is scheduled to receive data on the forward link, the CQI, e.g. the CQI including optimal rank and the CQI for that rank, may be computed based on beamformed pilot symbols, e.g. pilot symbols 322 from FIG. 3, and fedback over the reverse link control or signaling channel. In these cases, the channel estimate includes eigenbeamforming gains and provides more accurate rate and rank prediction for the next packet. Also, in some embodiments, the beamforming-CQI may be punctured periodically with the broadband CQI, and hence may not always be available, in such embodiments.

If the access terminal is scheduled to receive data on the forward link and the reverse link, the CQI, e.g. CQI, may be based on beamformed pilot symbols and can also be reported in-band, i.e. during the reverse link transmission to the access point.

In another embodiment, the access terminal can calculate the broadband pilot based CQI and hop-based pilot channel CQI for all ranks. After this, it can compute the beamforming gain which is provided due to beamforming at the access point. The beamforming gain may be calculated by the difference between the CQI of the broadband pilots and the hop-based pilots. After the beamforming gain is calculated, it may be factored into the CQI calculations of the broadband pilots to form a more accurate channel estimate of the broadband pilots for all ranks. Finally, the CQI, which includes the optimal rank and channel estimate for that rank, is obtained from this effective broadband pilot channel estimate and fed back to the access point, via a control or signaling channel.

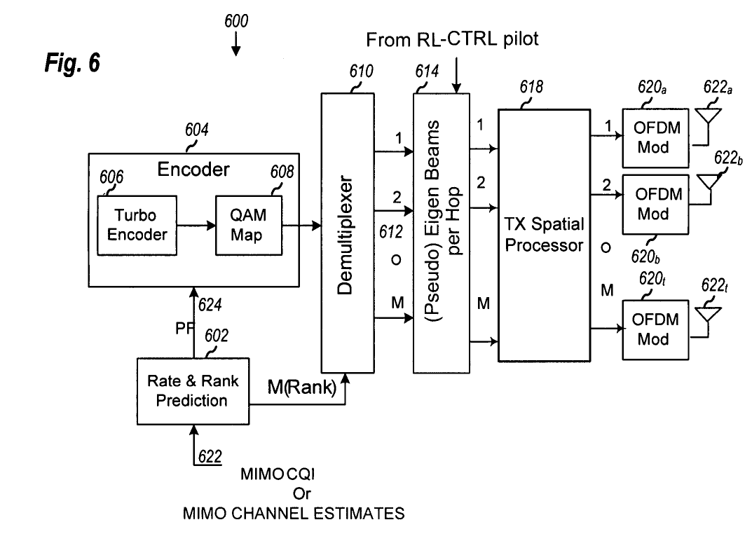

Referring to FIG. 6, a block diagram of a transmitter system in a multiple access wireless communication system according to one embodiment is illustrated. Transmitter 600, based upon channel information, utilizes rate prediction block 602 which controls a single-input single-output (SISO) encoder 604 to generate an information stream.

Bits are turbo-encoded by encoder block 606 and mapped to modulation symbols by mapping block 608 depending on the packet format (PF) 624, specified by a rate prediction block 602. The coded symbols are then de-multiplexed by a demultiplexer 610 to M_{T} layers 612, which are provided to a beamforming module 614.

Beamforming module 614 generates beamforming weights used to alter a transmission power of each of the symbols of the M_{T} layers 612 depending on the access terminals to which they are to be transmitted. The eigenbeam weights may be generated from the control or signaling channel information transmitted by the access terminal to the access point. The beamforming weights may be generated according to any of the embodiments as described above with respect to FIGS. 5A and 5B.

The M_{T} layers 612 after beamforming are provided to OFDM modulators 618a to 618t that interleave the output symbol streams with pilot symbols. The OFDM processing for each transmit antenna proceeds 620a to 620t then in an identical fashion, after which the signals are transmitted via a MIMO scheme.

In SISO encoder 604, turbo encoder 606 encodes the data stream, and in an embodiment uses ⅕ encoding rate. It should be noted that other types of encoders and encoding rates may be utilized. Symbol encoder 608 maps the encoded data into the constellation symbols for transmission. In one embodiment, the constellations may be Quadrature-Amplitude constellations. While a SISO encoder is described herein, other encoder types including MIMO encoders may be utilized.

Rate prediction block 602 processes the CQI information, including rank information, which is received at the access point for each access terminal. The rank information may be provided based upon broadband pilot symbols, hop based pilot symbols, or both. The rank information is utilized to determine the number of spatial layers to be transmitted by rate prediction block 602. In an embodiment, the rate prediction algorithm may use a 5-bit CQI feedback 622 approximately every 5 milliseconds. The packet format, e.g. modulation rate, is determined using several techniques.

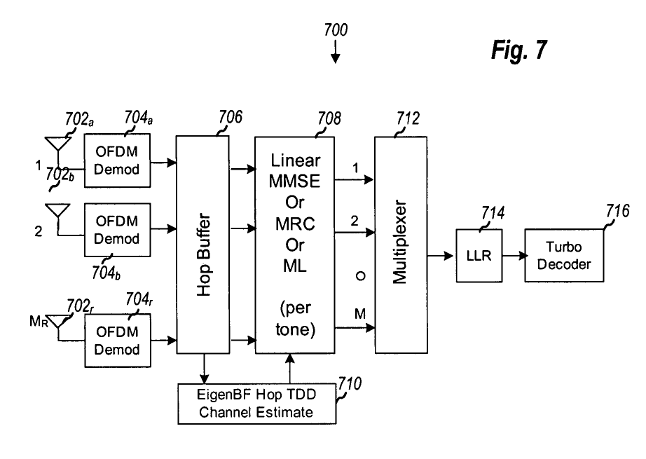

Referring to FIG. 7, a block diagram of a receiver system in a multiple access wireless communication system according to one embodiment is illustrated. In FIG. 7, each antenna 702a through 702t receives one or more symbols intended for the receiver 700. The antennas 702a through 702t are each coupled to OFDM demodulators 704a to 704t, each of which is coupled to hop buffer 706. The OFDM demodulators 704a to 704t each demodulate the OFDM received symbols into received symbol streams. Hop buffer 706 stores the received symbols for the hop region in which they were transmitted.

The output of hop buffer 706 is provided to an encoder 708, which may be a decoder that independently processes each carrier frequency of the OFDM band. Both hop buffer 706 and the decoder 708 are coupled to a hop based channel estimator 710 that uses the estimates of the forward link channel, with the eigenbeamweights to demodulate the information streams. The demodulated information streams provided by demodulator 712 are then provided to Log-Likelihood-Ratio (LLR) block 714 and decoder 716, which may be a turbo decoder or other decoder to match the encoder used at the access point, that provide a decoded data stream for processing.

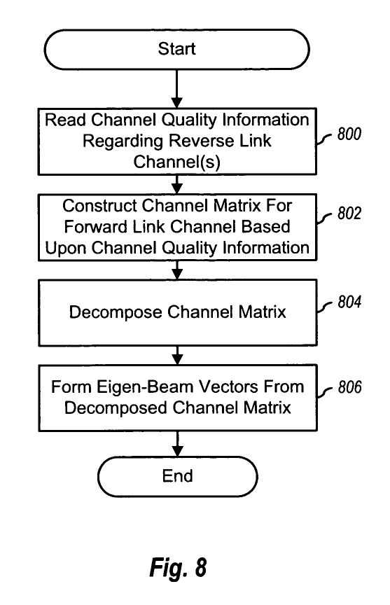

Referring to FIG. 8, a flow chart of generating beamforming weights according to one embodiment is illustrated. CQI information is read from a memory or buffer, block 800. In addition, the CQI information may be replaced with the eigenbeam feedback provided from the access terminal. The information may be stored in a buffer or may be processed in real time. The CQI information is utilized as a pilot to construct a channel matrix for the forward link, block 802. The beam-construction may be constructed as discussed with respect to FIGS. 5A and 5B. The beam-construction matrix is then decomposed, block 804. The decomposition may be a QR decomposition. The eigenvectors representing the beamforming weights can then be generated for the symbols of the next hop region to be transmitted to the access terminal, block 806.

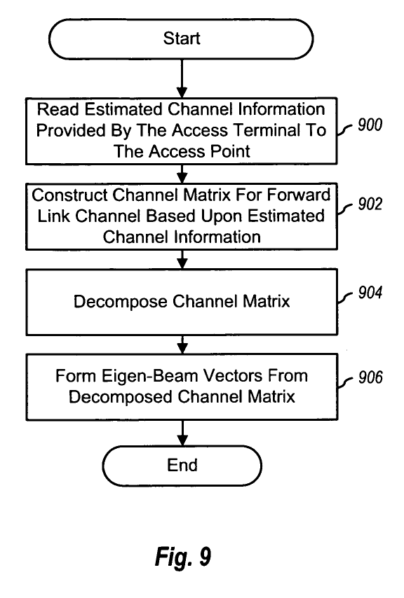

Referring to FIG. 9, a flow chart of generating beamforming weights according to another embodiment is illustrated. Channel estimate information provided from the access terminal is read from a memory or buffer, block 900. The channel estimate information may be stored in a buffer or may be processed in real time. The channel estimate information is utilized to construct a beam-construction matrix for the forward link, block 902. The beam-construction matrix may be constructed as discussed with respect to FIGS. 5A and 5B. The beam-construction matrix is then decomposed, block 904. The decomposition may be a QR decomposition. The eigenvectors representing the beamforming weights can then be generated for the symbols of the next hop region to be transmitted to the access terminal, block 906.

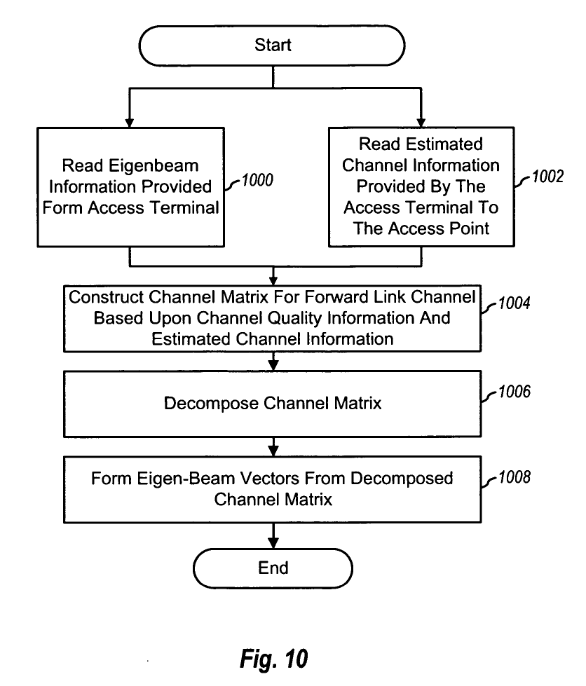

Referring to FIG. 10, a flow chart of generating beamforming weights according to a further embodiment is illustrated. Eigenbeam information provided from the access terminal is read from a memory or buffer, block 1000. In addition, channel information is also read, block 1002. The channel information may comprise CQI, channel estimates, and/or second order channel statistics, wherever generated originally. The eigenbeam information and channel information may be stored in a buffer or may be processed in real time. The eigenbeam information and channel information is utilized to construct a beam-construction matrix for the forward link, block 1004. The beam-construction matrix may be constructed as discussed with respect to FIGS. 5A and 5B. The beam-construction matrix is then decomposed, block 1006. The decomposition may be a QR decomposition. The eigenvectors representing the beamforming weights can then be generated for the symbols of the next hop region to be transmitted to the access terminal, block 1008.

The above processes may be performed utilizing TX processor 444 or 478, TX MIMO processor 446, RX processors 460 or 492, processor 430 or 470, memory 432 or 472, and combinations thereof. Further processes, operations, and features described with respect to FIGS. 5A, 5B, and 6-10 may be performed on any processor, controller, or other processing device and may be stored as computer readable instructions in a computer readable medium as source code, object code, or otherwise.

The techniques described herein may be implemented by various means. For example, these techniques may be implemented in hardware, software, or a combination thereof. For a hardware implementation, the processing units within a access point or a access terminal may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art.

The previous description of the disclosed embodiments is provided to enable any person skilled in the art to make or use the features, functions, operations, and embodiments disclosed herein. Various modifications to these embodiments may be readily apparent to those skilled in the art, and the generic principles defined herein may be applied to other embodiments without departing from their spirit or scope. Thus, the present disclosure is not intended to be limited to the embodiments shown herein but is to be accorded the widest scope consistent with the principles and novel features disclosed herein.

1. A wireless communication apparatus comprising:
at least two antennas; and
a processor configured to generate beamforming weights, for transmission of symbols to a wireless communication device, based upon channel information corresponding to a number of transmission paths, wherein the number of transmission paths is less than a total number of transmission paths from the wireless communication apparatus to the wireless communication device.

2. The wireless communication apparatus of claim 1, wherein the number of transmission paths is equal to the number of the at least two antennas.

3. The wireless communication apparatus of claim 1, wherein the channel information corresponds to one transmission path from each of the at least two antennas used for transmission.

4. The wireless communication apparatus of claim 1, wherein the channel information corresponds to one transmission path for each of the at least two antennas used for reception.

5. The wireless communication apparatus of claim 1, wherein the processor generates a channel matrix based upon the channel information and then generates beamforming weights utilizing the channel matrix.

6. The wireless communication apparatus of claim 5, wherein the processor decomposes the channel matrix by performing QR decomposition to generate the beamforming weights.

7. The wireless communication apparatus of claim 1, wherein the processor generates the channel information utilizing feedback received from the wireless communication device.

8. The wireless communication apparatus of claim 1, wherein the processor generates the channel information utilizing pilot symbols received from the wireless communication device.

9. The wireless communication apparatus of claim 1, wherein the processor generates the channel information utilizing feedback received from the wireless communication device and pilot symbols received from the wireless communication device.

10. The wireless communication apparatus of claim 1, wherein channel information comprises estimated channel information generated based upon a plurality of broadband pilot symbols.

11. The wireless communication apparatus of claim 1, wherein channel information comprises estimated channel information generated based upon a plurality of hop based pilot symbols.

12. The wireless communication apparatus of claim 1, wherein channel information comprises estimated channel information generated based upon a plurality of hop based pilot symbols and plurality of broadband pilot symbols.

13. The wireless communication apparatus of claim 1, wherein the processor further generates channel quality information, the channel quality information being based upon pilot symbols transmitted from at least one transmit antenna of a wireless communication device and received at the at least two antennas and wherein the channel information consists of the channel quality information.

14. The wireless communication apparatus of claim 13, wherein the channel quality information comprises signal to noise information.

15. The wireless communication apparatus of claim 1, wherein the processor is further configured to generate beamforming weights, for transmission of symbols to a wireless communication device, based upon both channel information and eigenbeam information.

16. A wireless communication apparatus comprising:
at least two antennas; and
means for generating beamforming weights based upon channel information corresponding to a number of transmission paths less than a number of transmission paths from transmission antennas of the at least two antennas to a wireless communication device.

17. The wireless communication apparatus of claim 16, wherein the number of transmission paths is equal to the number of the at least two antennas.

18. The wireless communication apparatus of claim 16, wherein the channel information corresponds to one transmission path from each of the at least two antennas used for transmission.

19. The wireless communication apparatus of claim 16, wherein the channel information corresponds to one transmission path for each of the at least two antennas used for reception.

20. The wireless communication apparatus of claim 16, wherein channel information comprises estimated channel information generated based upon a plurality of broadband pilot symbols.

21. The wireless communication apparatus of claim 16, wherein channel information comprises estimated channel information generated based upon a plurality of hop based pilot symbols.

22. The wireless communication apparatus of claim 16, wherein channel information comprises estimated channel information generated based upon a plurality of hop based pilot symbols and plurality of broadband pilot symbols.

23. The wireless communication apparatus of claim 16, wherein the channel information comprises channel quality information.

24. The wireless communication apparatus of claim 23, wherein the channel quality information comprises signal to noise information.

25. The wireless communication apparatus of claim 16, further comprising means for generating a channel matrix based upon the channel information and wherein the means for generating the beamforming weights utilizes the channel matrix to generate the beamforming weights.

26. The wireless communication apparatus of claim 25, wherein the circuit decomposes the channel matrix comprises means for performing QR decomposition.

27. The wireless communication apparatus of claim 16, further comprising means for generating a channel matrix based upon feedback received from the wireless communication device and wherein the means for generating the beamforming weights utilizes the channel matrix to generate the beamforming weights.

28. The wireless communication apparatus of claim 16, further comprising means for generating a channel matrix based upon pilot symbols received from the wireless communication device and wherein the means for generating the beamforming weights utilizes the channel matrix to generate the beamforming weights.

29. The wireless communication apparatus of claim 16, further comprising means for generating a channel matrix based upon utilizing feedback received from the wireless communication device and pilot symbols received from the wireless communication device, and wherein the means for generating the beamforming weights utilizes the channel matrix to generate the beamforming weights.

30. The wireless communication apparatus of claim 15, wherein the means for generating comprises means for generating the beamforming weights based upon both channel information and eigenbeam information.

31. A method for forming beamforming weights comprising:
reading channel information corresponding to a number of transmission paths, that is less than a number of transmission paths between a wireless transmitter and a wireless receiver;
generating beamforming weights based upon the channel information for transmission from the transmit antennas of the wireless transmitter.

32. The method of claim 31, wherein the number of transmission paths is less than a number of transmit antennas of the wireless transmitter.

33. The method of claim 31, wherein the channel information corresponds to one transmission path for each transmit antenna of the wireless transmitter.

34. The method of claim 31, wherein the channel information corresponds to one transmission path.

35. The method of claim 31, wherein channel information comprises estimated channel information generated based upon a plurality of broadband pilot symbols.

36. The method of claim 31, wherein channel information comprises estimated channel information generated based upon a plurality of hop based pilot symbols.

37. The method of claim 31, wherein channel information comprises estimated channel information generated based upon a plurality of hop based pilot symbols and plurality of broadband pilot symbols.

38. The method of claim 31, wherein the channel information comprises channel quality information.

39. The wireless communication apparatus of claim 38, wherein the channel quality information comprises signal to noise information.

40. A wireless communication apparatus comprising:
at least two antennas; and
a processor configured to generate beamforming weights, for transmission of symbols to a wireless communication device, based upon channel information corresponding to a number of receive antennas of the wireless communication device, wherein the number of receive antennas is less than a total number of antennas utilized for reception at the wireless communication device.

41. The wireless communication apparatus of claim 40, wherein the number of receive antennas is equal to one.

42. The wireless communication apparatus of claim 38, wherein the processor generates a channel matrix based upon the channel information and then generates beamforming weights utilizing the channel matrix.

43. The wireless communication apparatus of claim 42, wherein the processor decomposes the channel matrix comprises means for performing QR decomposition.

44. The wireless communication apparatus of claim 42, wherein the processor generates the channel information utilizing feedback received from the wireless communication device.

45. The wireless communication apparatus of claim 42, wherein the processor generates the channel information utilizing pilot symbols received from the wireless communication device.

46. The wireless communication apparatus of claim 42, wherein the processor generates the channel information utilizing feedback received from the wireless communication device and pilot symbols received from the wireless communication device.

47. The wireless communication apparatus of claim 46, wherein the processor further generates channel quality information, the channel quality information being based upon pilot symbols transmitted from at least one transmit antenna of the wireless communication device and received at the at least two antennas and wherein the channel information consists of the channel quality information.

48. The wireless communication apparatus of claim 47, wherein the channel quality information comprises signal to noise information.

49. The wireless communication apparatus of claim 42, wherein the processor is further configured to generate beamforming weights, for transmission of symbols to a wireless communication device, based upon both channel information and eigenbeam information.

50. A wireless communication apparatus comprising:
at least two antennas; and
means for generating beamforming weights based upon channel information corresponding to a number of channels less than a number of receive antennas at a wireless communication device.

51. The wireless communication apparatus of claim 50, wherein the number of receive antennas equal to one.

52. The wireless communication apparatus of claim 50, wherein the channel information comprises channel quality information.

53. The wireless communication apparatus of claim 52, wherein the channel quality information comprises signal to noise information.

54. The wireless communication apparatus of claim 50, further comprising means for generating a channel matrix based upon the channel information and wherein the means for generating the beamforming weights utilizes the channel matrix to generate the beamforming weights.

55. The wireless communication apparatus of claim 54, wherein the circuit decomposes the channel matrix comprises means for performing QR decomposition.

56. The wireless communication apparatus of claim 54, further comprising means for generating a channel matrix based upon feedback received from the wireless communication device and wherein the means for generating the beamforming weights utilizes the channel matrix to generate the beamforming weights.

57. The wireless communication apparatus of claim 54, further comprising means for generating a channel matrix based upon pilot symbols received from the wireless communication device and wherein the means for generating the beamforming weights utilizes the channel matrix to generate the beamforming weights.

58. The wireless communication apparatus of claim 54, further comprising means for generating a channel matrix based upon feedback received from the wireless communication device and pilot symbols received from the wireless communication device, and wherein the means for generating the beamforming weights utilizes the channel matrix to generate the beamforming weights.

59. The wireless communication apparatus of claim 50, wherein the means for generating comprises means for generating the beamforming weights based upon both channel information and eigenbeam information.
